(19) United States
(12) Patent Application Publication
(10) Pub. No.: US 2018/0328371 A1
(43) Pub. Date: Nov. 15, 2018

(54) BACKPLATE AND METHOD OF MAKING AND USING THE SAME

(71) Applicant: BorgWarner Inc., Auburn Hills, MI (US)

(72) Inventors: Robert Race, Arden, NC (US); Erwin Perry Ellwood, III, Candler, NC (US); Jonathan Williams, Clinton, TN (US)

(21) Appl. No.: 15/590,347

(22) Filed: May 9, 2017

(51) Int. Cl. F04D 29/02; F04D 29/00; F02D 23/00; B21D 28/02; B21D 28/14

(52) U.S. Cl. CPC F04D 29/023; F04D 29/00; B21D 28/14; B21D 28/02; F02D 23/00

(57) ABSTRACT

A number of variations may include a product comprising: a turbocharger comprising a rotor comprising a shaft having a rotation axis; a bearing at least partially surrounding the shaft allowing for rotation of the shaft within the bearing about the rotation axis, a bearing housing at least partially surrounding the bearing; a turbine housing defining a turbine chamber; a compressor housing defining a compressor chamber; a turbine wheel disposed in said turbine chamber and operatively connected to the shaft; a compressor wheel disposed in said compressor chamber and operatively connected to the shaft; and a compressor backplate disposed between the compressor housing and the bearing housing, wherein the backplate is constructed and arranged to attach to the compressor housing and the bearing housing.

### TECHNICAL FIELD

The field to which the disclosure generally relates to includes backplates and methods of making and using the same.

### BACKGROUND

In a number of variations, backplates may be used as components in turbochargers and/or turbocharger housings.

### SUMMARY OF ILLUSTRATIVE VARIATIONS

A number of variations may include a product comprising: a turbocharger comprising a rotor comprising a shaft having a rotation axis; a bearing at least partially surrounding the shaft allowing for rotation of the shaft within the bearing about the rotation axis, a bearing housing at least partially surrounding the bearing; a turbine housing defining a turbine chamber; a compressor housing defining a compressor chamber; a turbine wheel disposed in said turbine chamber and operatively connected to the shaft; a compressor wheel disposed in said compressor chamber and operatively connected to the shaft; and a compressor backplate disposed between the compressor housing and the bearing housing, wherein the backplate is constructed and arranged to attach to the compressor housing and the bearing housing.

A number of variations may include a method comprising: providing a turbocharger comprising a rotor comprising a shaft having a rotation axis; a bearing at least partially surrounding the shaft allowing for rotation of the shaft within the bearing about the rotation axis, a bearing housing at least partially surrounding the bearing; a turbine housing defining a turbine chamber; a compressor housing defining a compressor chamber; a turbine wheel disposed in said turbine chamber and operatively connected to the shaft; a compressor wheel disposed in said compressor chamber and operatively connected to the shaft; providing a compressor backplate, disposing the backplate between the compressor housing and the bearing housing; attaching the backplate to the compressor housing and the bearing housing; and operating the turbocharger.

A number of variations may include a method comprising: providing a press mechanism comprising a press comprising an upper die and a lower die; providing a blank comprising a metal between the upper die and the lower die; contacting the upper die and the lower die to stamp the blank into a stamped part comprising a compressor backplate, wherein the backplate is constructed and arranged to attach to a compressor housing and a bearing housing; separating the upper die from the lower die; and removing the compressor backplate from the press mechanism.

Other illustrative variations within the scope of the invention will become apparent from the detailed description provided hereinafter. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 illustrates a section view of a turbocharger according to a number of variations.

FIG. 2 illustrates a section view of a turbocharger according to a number of variations.

FIG. 3 illustrates a perspective section view of a turbocharger according to a number of variations.

FIG. 4 illustrates a section view of a turbocharger according to a number of variations.

FIG. 5 illustrates a close-up section view of a backplate in a turbocharger according to a number of variations.

FIG. 6 illustrates a close-up section view of a backplate in a turbocharger according to a number of variations.

FIG. 7 illustrates a close-up section view of a backplate in a turbocharger according to a number of variations.

FIG. 8 illustrates a close-up section view of a backplate in a turbocharger according to a number of variations.

FIG. 9 illustrates a perspective view of a turbocharger according to a number of variations.

FIG. 10 illustrates a perspective partial section view of a turbocharger according to a number of variations.

### DETAILED DESCRIPTION OF ILLUSTRATIVE VARIATIONS

The following description of the variations is merely illustrative in nature and is in no way intended to limit the scope of the invention, its application, or uses.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

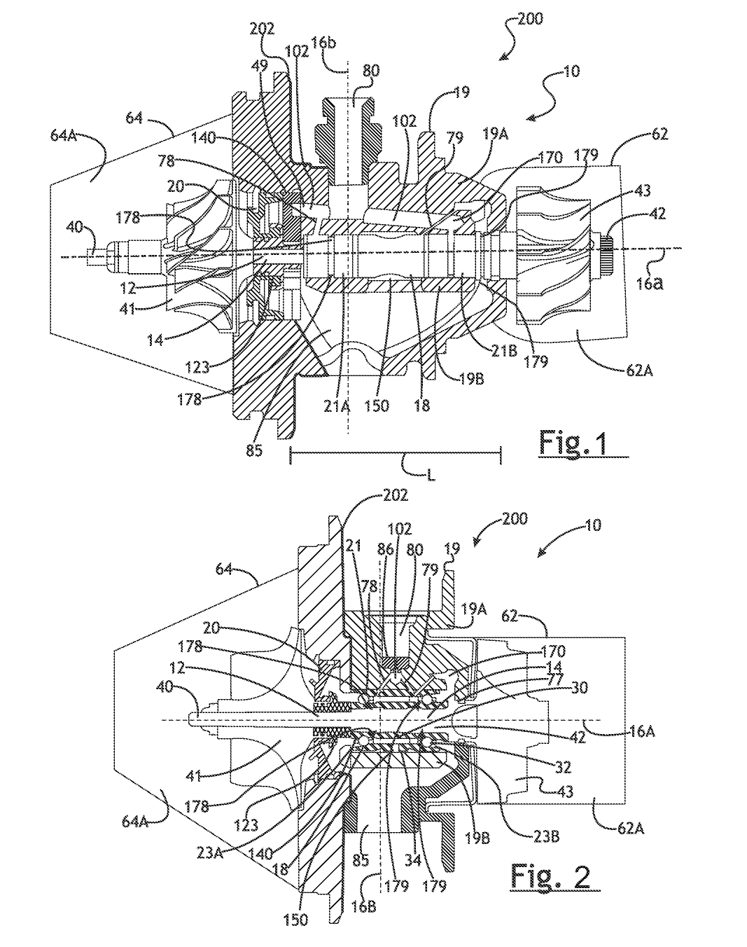

FIGS. 1-2 illustrate a product 10 according to a number of variations. In a number of variations, the product 10 may include a rotor 12. In a number of variations, the rotor 12 may include a shaft 14 having a rotational axis illustrated by line 16a. In a number of variations, the shaft 14 may have a radial axis illustrated by line 16b. In a number of variations, the product 10 may further comprise at least one bearing 18 which may at least partially surround the shaft 14. In a number of variations, the bearing 18 may have a length L. In a number of variations, the product 10 may include any component including a bearing 18 at least partially surrounding a shaft 14 and may include, but is not limited to, a centrifuge, a brake, a motor, a turbine, an appliance comprising a rotating component, or may be another type. In a number of variations, the product 10 may comprise a turbocharger. In a number of variations, the product 10 may be a turbocharger used in a vehicle. In a number of variations, the vehicle may include a motor vehicle, watercraft, spacecraft, aircraft, or may be another type. In a number of variations, the product 10 may be another device including a rotor including, but not limited to, a gas turbine, a turboprop engine, an auxiliary power unit, a turboshaft engine, a radial turbine, an axial turbine, a radial compressor, an axial compressor, a supercharger, a pump, a drilling rig, a microturbine, a turbine generator, a magnetic turbocharger, a journal bearing turbocharger system, an oil-free turbocharger bearing system, or may be another device. In a number of variations, the shaft 14 may include a compressor end 40. In a number of variations, the compressor end 40 may include a compressor wheel 41 which may rotate along the rotational axis 16a. In a number of variations, the compressor wheel 41 may be on or operatively connected to the shaft 14. In a number of variations, the shaft 14 may include a turbine end 42. In a number of variations, the turbine end 42 may include a turbine wheel 43 which may rotate along the rotational axis 16a. In a number of variations, the turbine wheel 43 may be on or operatively connected to the shaft 14. In a number of variations, the bearing 18 may allow for rotation of the shaft 14 within the bearing 18 along the rotational axis 16a. In a number of variations, the product 10 or bearing 18 may include a bearing housing 19. In a number of variations, the bearing housing 19 may include a top side 19A and a bottom side 19B. In a number of variations, the bearing 18 may be a journal bearing, a variation of which is illustrated in FIG. 1. In a number of variations, the bearing 18 may include a first journal bearing 21A and a second journal bearing 21B in the bearing housing 19. In a number of variations, a spacer 150 may be located between the first journal bearing 21A and the second journal bearing 21B. In a number of variations, the bearing 18 may be a rolling element bearing (REB) 23, a variation of which is illustrated in FIG. 2. In a number of variations, the bearing 18 may include a first REB 23A and a second REB bearing 23B in the bearing housing 19. In a number of variations, a spacer 150 may be located between the first REB 23A and the second REB 23B. In a number of variations, the rolling element bearing 18 may include an inner race 30 (or races), an outer race 34 (or races) and at least one rolling element 32. Unless otherwise indicated, the term “race” shall refer to the metal (or ceramic) element with one or more tracks contacted by the rolling elements, and the term “REB” used herein will encompass both types of REB cartridges. In a number of variations, at the compressor end 40, an insert 20 may at least partially annularly surround at least a portion of a thrust collar 123.

Referring to FIGS. 1-2, in a number of variations, 1-2, the turbocharger 10 or bearing housing 19 may include a turbine housing 62. In a number of variations, the turbine housing 62 may define a turbine chamber 62A which may house the turbine wheel 43. In a number of variations, the turbocharger 10 or bearing housing 19 may include a compressor housing 64. In a number of variations, the compressor housing 64 may define a compressor chamber 64A which may house the compressor wheel 41. In a number of variations, the compressor wheel 41 and the turbine wheel 43 may both be solidly affixed to the shaft 14. In a number of variations, a number of fasteners (not illustrated), may be used to secure the bearing housing 19 to the turbine side housing 62, compressor side housing 64, or any of their individual components. In a number of variations, the product 10 may be fed with a fluid, which may comprise oil or coolant or may comprise another fluid, to perform various functions on the bearing 18, shaft 14, and turbocharger 10 including, but not limited to, lubrication of the shaft 14 or the bearing 18, and/or cooling of all components within the turbocharger 10 including, but not limited to, the shaft 14, bearing, 18, or bearing housing 19. In a number of variations, the pressure, temperature, or flowrate of the fluid may impact the performance of the turbocharger 10. In a number of variations, the fluid may perform the function of providing a hydrodynamic squeeze film which exerts force on the shaft 14 or bearing 18.

In a number of variations, the fluid may be introduced to the product through a fluid delivery system 200. In a number of variations, the fluid delivery system 200 may be provided with a supply line at a fluid inlet 80, which may be interconnected with an associated engine's pressurized oil delivery system. In a number of variations, the oil delivery system 200 may deliver fluid to the bearing housing 19 through the fluid inlet 80. In a number of variations, an oil restrictor/post 86 may be fitted to the fluid inlet 80 to restrict the flow of fluid to the bearing housing 19. In a number of variations, the fluid delivery system 200 fluid inlet 80 may spread into at least one fluid delivery system 200 longitudinal passageway 102, a variation of which is illustrated in FIGS. 1-2. In a number of variations, the oil restrictor/post 86 may limit the oil from the fluid inlet 80 to the longitudinal passageway 102. In a number of variations, the longitudinal passageway 102 may be intersected by at least one fluid delivery system 200 fluid inlet passage 78, 79 that may extend around the axis of rotation 16a and may interconnect the fluid passageway 102 with the bearing 18. In a number of variations, the longitudinal passageway 102 may provide fluid from the fluid inlet 80 to at least one fluid inlet passage 78, 79. In a number of variations, the fluid inlet passages 78, 79 may take the form of annular grooves or jets that open into a gap to supply the bearing 18 with fluid. In a number of variations, the longitudinal passageway 102 may be cut or cross drilled from the turbine end 42 of the bearing housing 19 and may have a blind end 49. In a number of variations, the longitudinal passageway 102 may provide fluid to a thrust bearing 140. In a number of variations, the fluid may be fed through fluid inlet 80 to the fluid inlet passages 78, 79 to the bearing 18, a variation of which is illustrated in FIG. 2. In a number of variations, secondary fluid outlet passages 178, 179 may feed fluid to the shaft 14 through the bearing 18. In a number of variations, the fluid inlet 80, fluid inlet passages 78, 79 and/or longitudinal passageway 102 may be oriented along the side of the bearing 18 or bearing housing 19. In a number of variations, a plurality of fluid inlets 80, fluid inlet passages 78, 79 and/or longitudinal passageways 102 may be oriented along the side of the bearing 18 or bearing housing 19. In a number of variations, the fluid may be delivered to rotating shaft 14 and potentially rotating bearing 18 through the fluid inlet passages 78, 79 and the secondary fluid outlet passages 178, 179. In a number of variations, the fluid may exit the rotating shaft 14 and potentially rotating bearing 18 through the secondary fluid outlet passages 178, 179 and/or the fluid inlet passages 78, 79 to a fluid drain 85 on the bottom side 19B of the bearing housing 19. In a number of variations, the fluid drain 85 may return fluid to the associated engine.

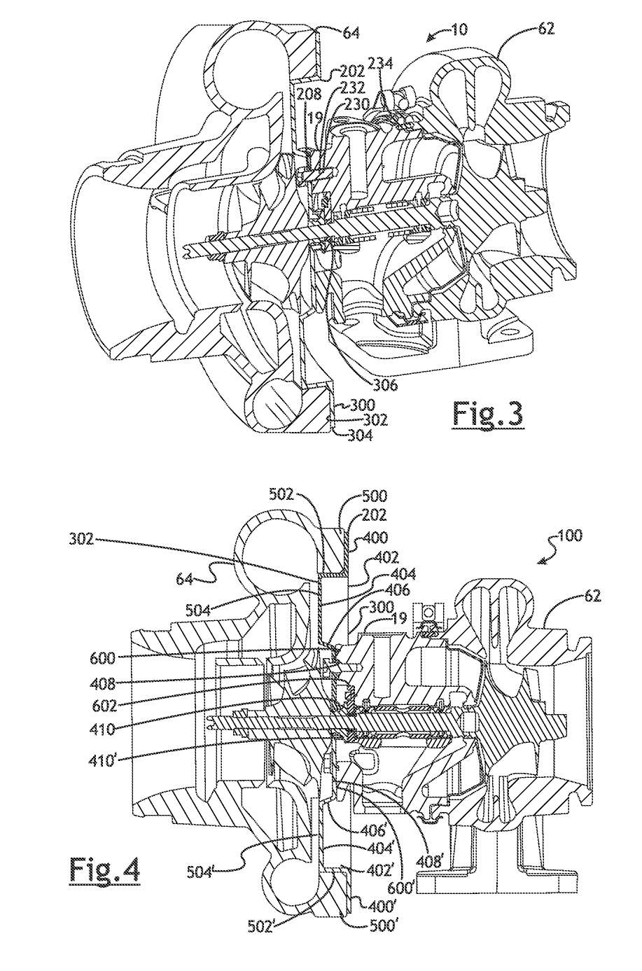

Referring to FIG. 3, in a number of variations, the product 10 or turbocharger 10 may further comprise a backplate 202. In a number of variations, the backplate 202 may be a compressor backplate 202. In a number of variations, the backplate 202 may include a first face 302 construction and arranged to interface with the compressor housing 64 and a second face 300 opposite of the first face 302 constructed and arranged to interface with the bearing housing 19. The backplate 202 may include an outer surface 304 which may extend between the outer periphery of the first face 302 and the second face 300 and an inner surface 306 may extend between the inner periphery of the first face 302 and the second face 300 and may define a through-hole which may be constructed and arranged to accommodate at least a portion of the turbocharger shaft 14. In a number of variations, the compressor backplate 202 may include at least one opening 208 which may extend though the first face 302 and the second face 300 and which may be constructed and arranged to accommodate at least one external attachment component 230 which may be used to attach the backplate 202 to the bearing housing 19 and/or the compressor housing 64, as will be discussed hereafter. In a number of variations, the opening 208 may comprise a threaded bore which may receive a threaded external attachment component 230.

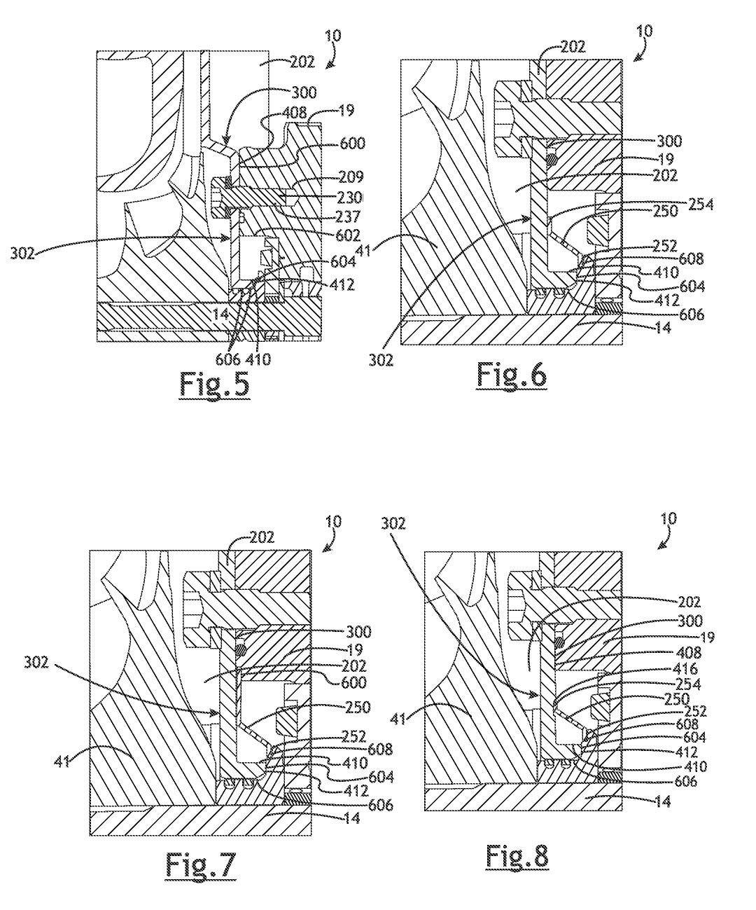

Referring to FIG. 4, in a number of variations, the backplate 202 may further comprise a plurality of component sections 400, 400′, 402, 402′, 404, 404′, 406, 406′, 408, 408′, 410, 410′, 412 (variations of which are illustrated in FIGS. 5-8). In a number of variations, the backplate 202 may include, on each radial side, a radial first projection flange 400, 400′. In a number of variations, the backplate 202 may include, on each radial side, radial second recess section 402, 402′. In a number of variations, the backplate 202 may include, on each radial side, a radial third trough section 404, 404′. In a number of variations, the backplate 202 may include, on each radial side, a radial fourth protrusion section 406, 406′. In a number of variations, the backplate 202 may include, on each radial side, a radial fifth plateau section 408, 408′. In a number of variations, the backplate 202 may include, on each radial side, a radial sixth projection flange section 410, 410′. Referring to FIGS. 5-8, in a number of variations, the backplate 202 may include, on each radial side, a radial seventh projection flange edge section 412.

In a number of variations, the backplate 202 may be a single continuous unitary component. In a number of variations, the backplate 202 may comprise any number of materials including, but not limited to, a metallic material including, but not limited to, steel. In a number of variations, the backplate 202 may be pre-machined. The backplate 202 may be formed in a number of variations including, but not limited to, stamping or a fine blanking process, as will be discussed hereafter. In a number of variations, the forming of the backplate using a stamping or fine blanking process may allow for the forming of thinner backplates 202 than cast aluminum or iron backplate designs may allow.

Referring to FIG. 5, in a number of variations, the bearing housing 19 may include at least one bearing housing opening 209. In a number of variations, the bearing housing opening 209 may be constructed and arranged to accommodate an external attachment 230. In a number of variations, the bearing housing opening 209 may comprise a threaded aperture for receiving a threaded external attachment 230. In a number of variations, the compressor housing 64 may include at least one compressor housing opening (not illustrated). In a number of variations, the compressor housing opening may be constructed and arranged to accommodate an external attachment 230. In a number of variations, the compressor housing opening may include a threaded aperture for receiving a threaded external attachment 230.

In a number of variations, the external attachment 230 may attach the backplate 202 to the compressor housing 64. In a number of variations, the external attachment 230 may attach the backplate 202 to the bearing housing 19. In a number of variations, the external attachment 230 may be at least one of a direct bolt 232, a v-band 234, or may be another type, variations of which are illustrated in FIG. 3. In a number of variations, the external attachment 230 may comprise a fastener 237, a variation of which is illustrated in FIG. 5.

Referring to FIG. 4, in a number of variations, the compressor housing 64 may comprise at least one component section 500, 500′, 502, 502′, 504, 504′. In a number of variations, the compressor housing 64 may include, on each radial side, a radial first projection plateau 500, 500′. In a number of variations, the compressor housing 64 may include, on each radial side, radial second recess section 502, 502′. In a number of variations, the compressor housing 64 may include, on each radial side, a radial third trough section 504, 504′. In a number of variations, the radial third trough section 504, 504′ may be substantially adjacent to the compressor wheel 41. In a number of variations, the compressor housing 64 may include a series of projections and recessions along at least one of the surfaces of the component sections 500, 500′, 502, 502′, 504, 504′ that may mechanically couple to the corresponding projections and recessions of at least one of the component sections 400, 402, 404, 406, 408, 410, 400′, 402′, 404′, 406′, 408′, 410′, 412, of the backplate 202. In a number of variations, the backplate 202 may include a series of projections and recessions along at least one of the surfaces of the component sections 400, 402, 404, 406, 408, 410, 400′, 402′, 404′, 406′, 408′, 410′, 412, that may mechanically couple to the corresponding projections and recessions of at least one of the component sections 500, 500′, 502, 502′, 504, 504′ of the compressor housing 64.

Referring again to FIG. 4, in a number of variations, the bearing housing 19 may comprise at least one component section 600, 600′, 602, 604, 606. In a number of variations, the bearing housing 19 may include, on each radial side, a radial first projection plateau 600, 600′. In a number of variations, the bearing housing 19 may include, on at least one radial side, radial second recess section 602. Referring to FIG. 5, in a number of variations, the bearing housing 19 may include, on at least one radial side, a radial third trough 604. In a number of variations, the bearing housing 19 may include, on at least one radial side, a radial fourth flange 606. In a number of variations, the bearing housing 19 may include a series of projections and recessions along at least one of the surfaces of the component sections 600, 600′, 602, 604, 606 that may mechanically couple to the corresponding projections and recessions of at least one of the component sections 400, 402, 404, 406, 408, 410, 400′, 402′, 404′, 406′, 408′, 410′, 412, of the backplate 202. In a number of variations, the backplate 202 may include a series of projections and recessions along at least one of the surfaces of the component sections 400, 402, 404, 406, 408, 410, 400′, 402′, 404′, 406′, 408′, 410′, 412, that may mechanically couple to the corresponding projections and recessions of at least one of the component sections 600, 600′, 602, 604, 606 of the bearing housing 19.

In a number of variations, the first face 302 of the backplate 202 may be attached to the compressor housing 64 through receiving component sections 500, 500′, 502, 502′, 504, 504′ in the compressor housing 64 mirroring and accepting at least one of the component sections 400, 402, 404, 406, 408, 410, 400′, 402′, 404′, 406′, 408′, 410′, 412, of the backplate 202. In a number of variations, the component sections 400, 402, 404, 406, 408, 410, 400′, 402′, 404′, 406′, 408′, 410′, 412 of the backplate 202 may comprise flanges and recesses that when paired with the component sections 500, 500′, 502, 502′, 504, 504′ of the compressor housing 64 are designed to accept attachment to the backplate 202 without need for an external attachment 230.

In a number of variations, the second face 300 of the backplate 202 may be attached to the bearing housing 19 through receiving component sections 600, 600′, 602, 604, 606 in the bearing housing 19 mirroring and accepting at least one of the component sections 400, 402, 404, 406, 408, 410, 400′, 402′, 404′, 406′, 408′, 410′, 412, of the backplate 202. In a number of variations, the component sections 400, 402, 404, 406, 408, 410, 400′, 402′, 404′, 406′, 408′, 410′, 412 of the backplate 202 may comprise flanges and recesses that when paired with the component sections 600, 600′, 602, 604, 606 of the bearing housing 19 are designed to accept attachment to the backplate 202 without need for an external attachment 230.

Referring to FIG. 6, in a number of variations, the backplate 202 may include at least one oil deflector 250. In a number of variations, the oil deflector 250 may include a leading edge 252. In a number of variations, the oil deflector 250 may include a trailing edge 254. In a number of variations, the radial third trough 604 may include a radial third trough recess 608 that accepts a lead edge 252 of the oil deflector 250. In a number of variations, the oil deflector 250 may be welded, bolted, riveted, or otherwise attached to the backplate 202 through its trailing edge 254. Referring to FIG. 7, in a number of variations, the oil deflector 250 may be clamped to the backplate 202 and the radial first projection plateau 600, 600′ of the bearing housing 19 through its trailing edge 254. Referring to FIG. 8, in a number of variations, the oil deflector 250 may be welded to the backplate 202 and may pilot on a recess 416 in the radial fifth plateau section 408, 408′ of the backplate 202 through its trailing edge 254.

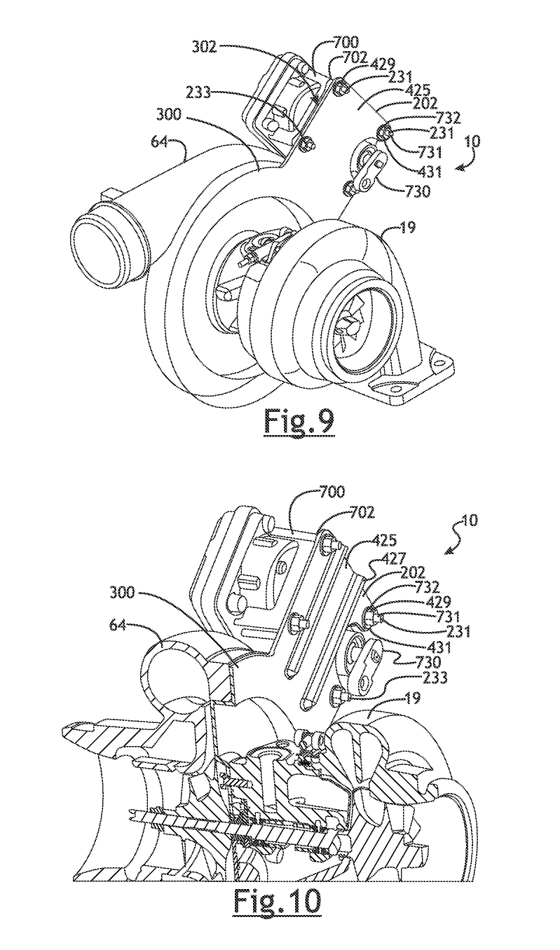

Referring to FIGS. 9-10, in a number of variations, the product 10 may include an actuator 700. In a number of variations, the actuator 700 may be a rotary electronic actuator, a linear pressure actuator, or may be another type. In a number of variations, the actuator 700 may include an actuator housing 702. In a number of variations, the backplate 202 may include an additional component section comprising a radial projection flange 425. In a number of variations, the actuator 700 may attach to the radial projection flange 425 of the backplate 202 through a radial projection flange attachment 431. In a number of variations, the radial projection flange attachment 431 may be constructed and arranged to attach the radial projection flange 425 of the backplate 202 to the actuator housing 702 or the actuator 700. In a number of variations, the radial projection flange 425 may include at least one rib 427, a variation of which is illustrated in FIG. 10. In a number of variations, the compressor backplate 202 may include at least one radial projection flange hole 429. In a number of variations, the hole 429 may be used to provide attachment to the radial projection flange attachment 231. In a number of variations, the hole 429 may include a threaded aperture for receiving the radial projection flange attachment 231. In a number of variations, the radial projection flange attachment 231 may attach the backplate 202 to the actuator housing 702. In a number of variations, the radial projection flange attachment 231 may be at least one of a direct bolt 731 and nut 732, a v-band, or may be another type. In a number of variations, the radial projection flange attachment 231 may include a fastener 233. Any number of variations of fasteners may be used including, but not limited to, mechanical fasteners. In a number of variations, the actuator 700 may include an actuator arm 730 to function as an actuator linkage to the product. The actuator 700 may function according to operation of the product 10 or turbocharger.

In a number of variations, a method is illustrated. In a number of variations, the method may include providing a turbocharger comprising a rotor comprising a shaft having a rotation axis; a bearing at least partially surrounding the shaft allowing for rotation of the shaft within the bearing about the rotation axis, a bearing housing at least partially surrounding the bearing; a turbine housing defining a turbine chamber; a compressor housing defining a compressor chamber; a turbine wheel disposed in said turbine chamber and operatively connected to the shaft; a compressor wheel disposed in said compressor chamber and operatively connected to the shaft. In a number of variations, the method may further include providing a compressor backplate. In a number of variations, the method may further include disposing the backplate between the compressor housing and the bearing housing. In a number of variations, the method may further include attaching the backplate to the compressor housing. In a number of variations, the method may further include operating the turbocharger.

In a number of variations, a second method is illustrated. In a number of variations, the method may include providing a press mechanism comprising a press comprising an upper die and a lower die. In a number of variations, the method may further include providing a blank comprising a metal between the upper die and the lower die. In a number of variations, the method may include contacting the upper die and the lower die to stamp the blank into a stamped part comprising a compressor backplate constructed and arranged to attach to a compressor housing. In a number of variations, the method may further include separating the upper die from the lower die. In a number of variations, the method may further include removing the compressor backplate from the press mechanism.

In a number of variations, the product, first method, or second method may improve ease in packaging and structural constraints of the product 10. In a number of variations, the product, first method, or second method may provide modularity and mass improvements in the components of the product 10. In a number of variations, the product, first method, or second method may allow for flexibility in design of the backplate 202 as the backplate 202 may be formed to a thickness much thinner than backplates formed by cast aluminum or iron backplates. In a number of variations, the product, first method, or second method may provide joint integrity in the components of the product 10. In a number of variations, the product, first method, or second method may provide improved performance during wheel burst of the product 10. In a number of variations, the product, first method, or second method may provide ease of assembly of flinger piston rings through the oil deflector 250 of the product. In a number of variations, the product, first method, or second method may provide minimal machining to the backplate 202 or the product 10.

The following description of variants is only illustrative of components, elements, acts, products and methods considered to be within the scope of the invention and are not in any way intended to limit such scope by what is specifically disclosed or not expressly set forth. The components, elements, acts, products and methods as described herein may be combined and rearranged other than as expressly described herein and still are considered to be within the scope of the invention.

Variation 1 may include a product comprising: a turbocharger comprising a rotor comprising a shaft having a rotation axis; a bearing at least partially surrounding the shaft allowing for rotation of the shaft within the bearing about the rotation axis, a bearing housing at least partially surrounding the bearing; a turbine housing defining a turbine chamber; a compressor housing defining a compressor chamber; a turbine wheel disposed in said turbine chamber and operatively connected to the shaft; a compressor wheel disposed in said compressor chamber and operatively connected to the shaft; and a compressor backplate disposed between the compressor housing and the bearing housing, wherein the backplate is constructed and arranged to attach to the compressor housing and the bearing housing.

Variation 2 may include a product as set forth in Variation 1 wherein the backplate comprises: a first face; a second face opposite of the first face; an outer surface extending between an outer periphery of the first face and the second face; an inner surface extending between an inner periphery of the first face and the second face defining a through-hole; at least one opening extending through the first face and the second face constructed and arranged to accommodate at least one external attachment component.

Variation 3 may include a product as set forth in Variation 2 wherein a portion of the first face and the second face includes a circular recess offset from the through-hole.

Variation 4 may include a product as set forth in any of Variations 1-3 wherein the backplate comprises steel.

Variation 5 may include a product as set forth in any of Variations 1-4 wherein the backplate further comprises a radial projection flange which extends from a portion of the outer surface of the backplate, and wherein the radial projection flange is constructed and arranged to attach to an actuator.

Variation 6 may include a product as set forth in Variation 5 wherein the radial flange further comprises at least one support rib.

Variation 7 may include a product as set forth in any of Variations 1-6 wherein the backplate is a single continuous unitary piece.

Variation 8 may include a product as set forth in any of Variations 1-7 further comprising an oil deflector attached to the second face of the backplate.

Variation 9 may include a method comprising: providing a turbocharger comprising a rotor comprising a shaft having a rotation axis; a bearing at least partially surrounding the shaft allowing for rotation of the shaft within the bearing about the rotation axis, a bearing housing at least partially surrounding the bearing; a turbine housing defining a turbine chamber; a compressor housing defining a compressor chamber; a turbine wheel disposed in said turbine chamber and operatively connected to the shaft; a compressor wheel disposed in said compressor chamber and operatively connected to the shaft; providing a compressor backplate; disposing the backplate between the compressor housing and the bearing housing; attaching the backplate to the compressor housing and the bearing housing; and operating the turbocharger.

Variation 10 may include a method as set forth in Variation 9 wherein the backplate comprises: a first face; a second face opposite of the first face; an outer surface extending between an outer periphery of the first face and the second face; an inner surface extending between an inner periphery of the first face and the second face defining a through-hole; and at least one opening extending through the first face and the second face constructed and arranged to accommodate at least one external attachment component.

Variation 11 may include a method as set forth in Variation 10 wherein a portion of the first face and the second face includes a circular recess offset from the through-hole.

Variation 12 may include a method as set forth in any of Variations 9-11 wherein the backplate comprises steel.

Variation 13 may include a method as set forth in any of Variations 10-12 wherein the backplate further comprises a radial projection flange extending from a portion of the outer surface of the backplate, and wherein the radial projection flange is constructed and arranged to attach to an actuator.

Variation 14 may include a method as set forth in any of Variations 9-13 wherein the backplate is a single continuous unitary component.

Variation 15 may include a method comprising: providing a press mechanism comprising a press comprising an upper die and a lower die; providing a blank comprising a metal between the upper die and the lower die; contacting the upper die and the lower die to stamp the blank into a stamped part comprising a compressor backplate, wherein the backplate is constructed and arranged to attach to a compressor housing and a bearing housing; separating the upper die from the lower die; and removing the compressor backplate from the press mechanism.

Variation 16 may include a method as set forth in Variation 15 wherein the backplate comprises: a first face; a second face opposite of the first face; an outer surface extending between an outer periphery of the first face and the second face; an inner surface extending between an inner periphery of the first face and the second face defining a through-hole; at least one opening extending through the first face and the second face constructed and arranged to accommodate at least one external attachment component.

Variation 17 may include a method as set forth in Variation 16 wherein a portion of the first face and the second face includes a circular recess offset from the through-hole.

Variation 18 may include a method as set forth in any of Variations 15-17 wherein the backplate comprises steel.

Variation 19 may include a method as set forth in any of Variations 16-18 wherein the backplate comprises a radial projection flange extending from a portion of the outer surface of the backplate, and wherein the radial projection flange is constructed and arranged to attach to an actuator.

Variation 20 may include a method as set forth in any of Variations 15-19 wherein the backplate is a single stamped piece.

The above description of select variations within the scope of the invention is merely illustrative in nature and, thus, variations or variants thereof are not to be regarded as a departure from the spirit and scope of the invention.

What is claimed is:

1. A product comprising: a turbocharger comprising a rotor comprising a shaft having a rotation axis; a bearing at least partially surrounding the shaft allowing for rotation of the shaft within the bearing about the rotation axis, a bearing housing at least partially surrounding the bearing; a turbine housing defining a turbine chamber; a compressor housing defining a compressor chamber; a turbine wheel disposed in said turbine chamber and operatively connected to the shaft; a compressor wheel disposed in said compressor chamber and operatively connected to the shaft; and a compressor backplate disposed between the compressor housing and the bearing housing, wherein the backplate is constructed and arranged to attach to the compressor housing and the bearing housing.

2. The product of claim 1 wherein the backplate comprises: a first face; a second face opposite of the first face; an outer surface extending between an outer periphery of the first face and the second face; an inner surface extending between an inner periphery of the first face and the second face defining a through-hole; at least one opening extending through the first face and the second face constructed and arranged to accommodate at least one external attachment component.

3. The product of claim 2 wherein a portion of the first face and the second face includes a circular recess offset from the through-hole.

4. The product as set forth in claim 1 wherein the backplate comprises steel.

5. The product as set forth in claim 1 wherein the backplate further comprises a radial projection flange which extends from a portion of the outer surface of the backplate, and wherein the radial projection flange is constructed and arranged to attach to an actuator.

6. The product as set forth in claim 5 wherein the radial flange further comprises at least one support rib.

7. The product as set forth in claim 1 wherein the backplate is a single continuous unitary piece.

8. The product as set forth in claim 1 further comprising an oil deflector attached to the second face of the backplate.

9. A method comprising:
providing a turbocharger comprising a rotor comprising a shaft having a rotation axis; a bearing at least partially surrounding the shaft allowing for rotation of the shaft within the bearing about the rotation axis, a bearing housing at least partially surrounding the bearing; a turbine housing defining a turbine chamber; a compressor housing defining a compressor chamber; a turbine wheel disposed in said turbine chamber and operatively connected to the shaft; a compressor wheel disposed in said compressor chamber and operatively connected to the shaft;
providing a compressor backplate;
disposing the backplate between the compressor housing and the bearing housing;
attaching the backplate to the compressor housing and the bearing housing; and
operating the turbocharger.

10. The method of claim 9 wherein the backplate comprises: a first face; a second face opposite of the first face; an outer surface extending between an outer periphery of the first face and the second face; an inner surface extending between an inner periphery of the first face and the second face defining a through-hole; and at least one opening extending through the first face and the second face constructed and arranged to accommodate at least one external attachment component.

11. The method of claim 10 wherein a portion of the first face and the second face includes a circular recess offset from the through-hole.

12. The method as set forth in claim 9 wherein the backplate comprises steel.

13. The method as set forth in claim 10 wherein the backplate further comprises a radial projection flange extending from a portion of the outer surface of the backplate, and wherein the radial projection flange is constructed and arranged to attach to an actuator.

14. The method as set forth in claim 9 wherein the backplate is a single continuous unitary component.

15. A method comprising:
providing a press mechanism comprising a press comprising an upper die and a lower die;
providing a blank comprising a metal between the upper die and the lower die;
contacting the upper die and the lower die to stamp the blank into a stamped part comprising a compressor backplate, wherein the backplate is constructed and arranged to attach to a compressor housing and a bearing housing;
separating the upper die from the lower die; and
removing the compressor backplate from the press mechanism.

16. The method of claim 15 wherein the backplate comprises: a first face; a second face opposite of the first face; an outer surface extending between an outer periphery of the first face and the second face; an inner surface extending between an inner periphery of the first face and the second face defining a through-hole; at least one opening extending through the first face and the second face constructed and arranged to accommodate at least one external attachment component.

17. The product of claim 16 wherein a portion of the first face and the second face includes a circular recess offset from the through-hole.

18. The method as set forth in claim 15 wherein the backplate comprises steel.

19. The method as set forth in claim 16 wherein the backplate comprises a radial projection flange extending from a portion of the outer surface of the backplate, and wherein the radial projection flange is constructed and arranged to attach to an actuator.

20. The method as set forth in claim 15 wherein the backplate is a single stamped piece.
